(19) United States
(12) Patent Application Publication
(10) Pub. No.: US 2004/0189971 A1
(43) Pub. Date: Sep. 30, 2004

(54) Wafer edge exposing apparatus

(75) Inventors: Doo-Hoon Goo, Suwon-si (KR); Si-Hyeung Lee, Hwaseong-si (KR)

Correspondence Address: F. CHAU & ASSOCIATES, LLP, Suite 501, 1900 Hempstead Turnpike, East Meadow, NY, 11554, US

(73) Assignee: SAMSUNG ELECTRONICS CO., LTD.

(21) Appl. No.: 10/807,659

(22) Filed: Mar. 24, 2004

(30) Foreign Application Priority Data
Mar. 25, 2003 (KR) 2003-18587

(51) Int. Cl. G03B 27/54

(52) U.S. Cl. 355/67

(57) ABSTRACT

A wafer edge exposing apparatus comprising: a light source device for generating source light; an optical fiber cord for guiding the source light generated from the light source into a light focusing device; a lens, positioned in the light focusing device to receive the source light from the optical fiber cord, the light focusing device to focus the source light to the edge of a wafer; and a wavelength converter for converting a wavelength of the source light to a wavelength corresponding to the highest absorptivity of a photoacid generator of resist coated on the wafer.

### BACKGROUND OF THE INVENTION

1. Technical Field

The present invention relates to an apparatus for manufacturing a semiconductor device and, more particularly, to a wafer edge exposing apparatus.

2. Discussion of Related Art

In general, to fabricate semiconductor devices processes such as an ion implantation process, a deposition process, a diffusion process, a photolithographic process, and an etching process are required. The photolithographic process is performed to form desired patterns on a wafer. During the photolithographic process, a photoresist is used to coat the wafer. The photoresist is a kind of photochemical reactant.

During the photolithographic process, a photoresist-coated wafer is carried and treated while its edge is held by a tweezer or a chuck. When the chuck or tweezer contacts the wafer edge, photoresist particles can be scattered on the contact surface. Conventionally, a wafer edge exposing apparatus is used to remove the photoresist particles.

A conventional wafer edge exposing apparatus includes a chuck, a light source, and an optical fiber cord. A wafer is placed on the chuck. The light source generates light. The optical fiber cord guides the light generated from the light source to the wafer edge.

In general, photoresist is induced differently depending on whether a light is irradiated to the photoresist. The differently induced photoresist forms a microcircuit pattern. Photoresist can be categorized as i-line resist, krypton fluoride (KrF) resist, argon fluoride (ArF) resist, E-beam resist, and X-ray resist. The photoresists are matched to the light source.

For example, ArF resist is used with an ArF excimer laser having 193 nm wavelength fitted for ArF resist. However, ArF excimer laser requires considerable initial installation cost and maintenance cost. Thus, KrF laser having 248 nm wavelength fitted for KrF resist is still used despite its shortcomings such as bad wafer edge exposing profile and longer process time. Moreover, by using KrF resist instead of ArF resist, light can travel even to a chip area. The light in the chip area may reduce overall yield.

### SUMMARY OF THE INVENTION

A wafer edge exposing apparatus is provided, comprising: a light source device for generating source light; an optical fiber cord for guiding the source light generated from the light source into a light focusing device; a lens positioned in the light focusing device to receive the source light from the optical fiber cord, the light focusing device to focus the source light to the edge of a wafer; and a wavelength converter for converting a wavelength of the source light to a wavelength corresponding to the highest absorptivity of a photoacid generator of resist coated on the wafer.

The light source device includes a lamp, a parabolic or elliptical mirror, a plate, a shutter, and a filter.

Preferably, the wavelength converter is made of an optically non-linear material. The optically non-linear material is one selected from the group consisting of beta barium borate (β-BaB₂O₄), lithium triborate (LiB₃O₅), cesium lithium borate (CsLiB₆O₁₀ ), potassium titanyl phosphate (KTiOPO₄), potassium titanyl arsenate (KTiOAsO₄), potassium dihydrogen phosphate (KH₂PO₄), deuterated ammonium dihydrogen phosphate (KD₂PO₄), ammonium dihydrogen phosphate (NH₄H₂PO₄), deuterated ammonium dihydrogen phosphate (ND₄H₂PO₄), rubidium dihydrogen phosphate (RbH₂PO₄), cesium dihydrogen arsenate (CsH₂AsO₄), deuterated cesium dihydrogen arsenate (CsH₂AsO₄), lithium niobate (LiVbO₃), lithium tantelate (LiTaO₃), lithium iodata (LiIO₃), potassium niobate (KNbO₃), barium nitrate (Ba(NO₃)₂), solid-state raman shifters (KGd(WO₄)₂), potassium pentaborate, 3-methyl-4-nitropyridine-1 oxide, L-ariginine phosphate, and combinations thereof.

Preferably, the resist is ArF resist. A lamp for generating light is an ultraviolet lamp, and the source light is i-line. The wavelength converter is made of either one of potassium titanyl phosphate (KTiOPO₄) and potassium dihydrogen phosphate (KH₂PO₄).

Preferably, the wavelength converter is positioned at the end of the light-focusing device. The wavelength converter is attachable/removable. Alternatively, the wavelength converter is positioned in front of the lamp. The wavelength converter is positioned between an optical fiber cord and a light source device. The wavelengths converter is positioned between the filter and the optical fiber cord.

Preferably, an anti-reflective coating film (ARC) is coated on a surface of the wavelength converter. The anti-reflective coating film (ARC) is made of one selected from the group consisting of zirconia (ZrO₂), magnesia (MgO), silica (SiO₂), titania (TiO₂), and combinations thereof.

A wafer edge exposing apparatus is provided, comprising: a light source device for generating a source light; an optical fiber cord for guiding the source light; a light focusing device for receiving the source light, focusing the source light into a wafer; and a wavelength converter for converting the wavelength of the source light to the wavelength corresponding to the highest absorptivity of a photoacid generator in resist on the wafer.

### BRIEF DESCRIPTION OF THE DRAWINGS

FIG. 1 is a perspective view of a wafer edge exposing apparatus according to a preferred embodiment of the present invention.

FIG. 2 shows the inside of a light source device shown in FIG. 1.

FIG. 3 is a cross-sectional view of alight focusing device shown in FIG. 1.

FIG. 4 is a graph showing the absorptivity versus wavelengths of a plurality of photoacid generators (PAGs).

FIG. 5 shows the conversion in wavelength of i-line using a wavelength converter.

FIG. 6 shows a wavelength converter coated with an anti-reflective coating film (ARC).

FIG. 7A through FIG. 7D show embodiments of installation of a wavelength converter.

### DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this invention will be through and complete, and will fully convey the scope of the invention to those skilled in the art.

In preferred embodiments, ArF resist is described as resist coated on a wafer. However, a plurality of resists such as i-line resist, KrF resist, E-beam resist, and X-ray resist can also be used.

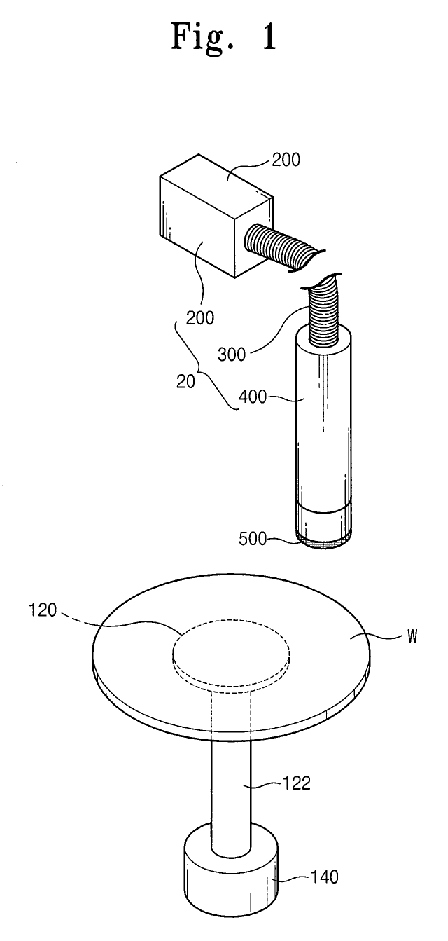

Referring to FIG. 1, a wafer edge exposing apparatus includes a chuck 120, a chuck rotator 140, a supporter 122, and an exposing device 20.

The chuck 120 is a disk-shaped device on which a wafer W is placed. The supporter 122 supports the chuck 120 and the chuck rotator 140. The chuck rotator 140 includes a stepping motor (not shown) for rotating the supporter 122. In the supporter 122, a vacuum line (not shown) is formed to absorb the wafer W onto the chuck 120. Alternatively, a wafer may be fixed on the chuck 120 by known chemical means.

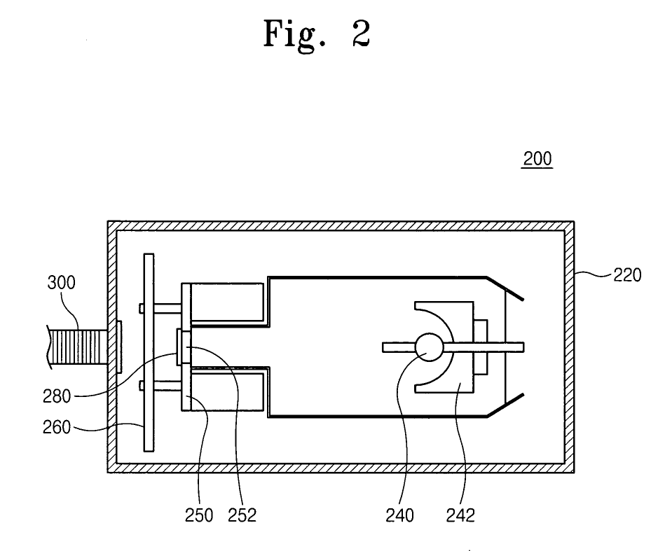

The exposing device 20 exposes the edge of the wafer W placed on the chuck 120. The exposing device 20 includes a light source device 200, an optical fiber cord 300, and a light-focusing device 400. The light source device 200 includes a lamp (240 in FIG. 2) generating source light. The optical fiber cord 300 guides the source light. The light-focusing device 400 receives the source light from the optical fiber cord 300 and irradiates the edge of the wafer W.

The inside of the light source device 200 is illustrated in FIG. 2. The light source device 200 has a lamp 240, a parabolic or elliptical mirror 242, a housing 220, a plate 250, a shutter 280, and a filter 260.

The lamp 240 generates the source light. The parabolic or elliptical mirror 242 encircles a portion of the lamp 240 to focus the source light generated from the lamp 240. A hole 252, which is a light-running passage, is formed at the plate 250. The shutter 280 rotates or moves upwardly or downwardly by means of a motor or a cylinder to open/close the hole 252. A filter 260 is installed in the housing 220. The filter 260 is made to pass light having a particular wavelength.

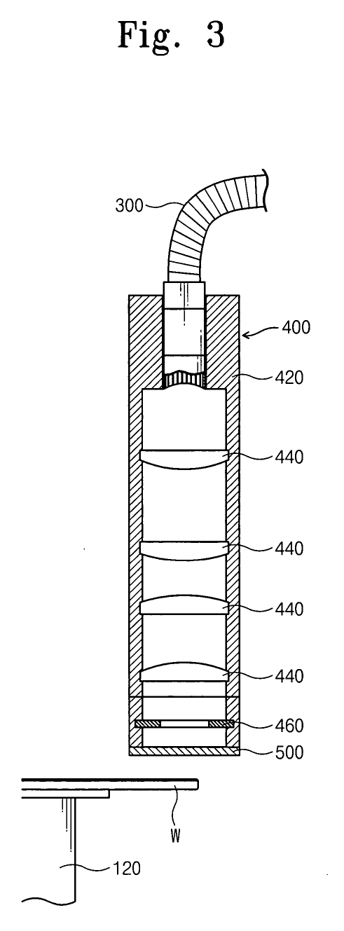

Referring to FIG. 3, the light focusing device 400 has a cylindrical housing 420 and a plurality of lenses 440. The optical fiber cord 300 is connected to an upper surface of the housing 420. The plurality of lenses 440 are positioned in the housing 420 and receive source light from the optical fiber cord 300 to focus the source light to the edge of the wafer W.

ArF resist is a chemically amplified photoresist. The chemically amplified photoresist is a type of photoresist where the exposure reaction initiates a chain reaction of chemical events. The chemically amplified photoresist contains a photoacid generator (hereinafter referred to as “PAG”) and an acid labile polymer or compound.

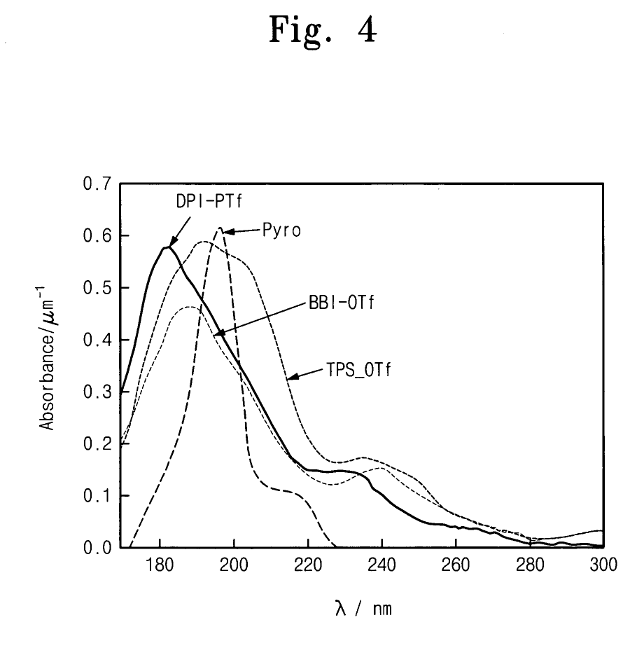

The absorptivity according to wavelengths based on kinds of PAGs is now described with reference to FIG. 4. The PAGs shown in FIG. 4 are DPI-PTf, Pyro, BBI-OTf, and TPS_OTf. The vertical axis represents absorptivity, and the horizontal axis represents wavelengths of projected light. The PAGs in FIG. 4 are shown to have about five times higher absorptivity at 193 nm wavelength as compared to the absorptivity at 248 nm wavelength. Thus, the process time using 193 nm wavelength is ⅕ shorter as compared to the process time using 248 nm wavelength.

When ArF resist is coated on a wafer, ArF excimer laser having 193 nm wavelength is preferably used as light source. However, the ArF excimer laser requires considerable initial installation cost and maintenance cost.

In one embodiment of the present invention, a lower-cost mercury arc lamp is used. The mercury arc lamp generates spectrum and the filter 260 receives the spectrum and passes light having a particular wavelength. The source light, in this embodiment, is i-line having 365.48 nm wavelength. To produce a source light having a wavelength fitted to the ArF resist, a wavelength converter 500 converts the i-line wavelength to 193 nm. Alternatively the source light passed by the filter 260 may be one of lights having a wavelength within the ultraviolet range (i.e. 315 nm to 400 nm).

The wavelength converter 500 is made of an optically non-linear material for converting a wavelength of the source light. The optically non-linear material can be one of second harmonic generating materials for converting a wavelength to ½ wavelength or third harmonic generating material for converting a wavelength to ⅓ wavelength.

The optically non-linear material can be one selected from the group consisting of beta barium borate (β-BaB₂O₄), lithium triborate (LiB₃O₅), cesium lithium borate (CsLiB₆O₁₀), potassium titanyl phosphate (KTiOPO₄), potassium titanyl arsenate (KTiOAsO₄), potassium dihydrogen phosphate (KH₂PO₄), deuterated ammonium dihydrogen phosphate (KD₂PO₄), ammonium dihydrogen phosphate (NH₄H₂PO₄), deuterated ammonium dihydrogen phosphate (ND₄H₂PO₄), rubidium dihydrogen phosphate (RbH₂PO₄), cesium dihydrogen arsenate (CsH₂AsO₄), deuterated cesium dihydrogen arsenate (CsH₂AsO₄), lithium niobate (LiVbO₃), lithium tantelate (LiTaO₃), lithium iodata (LiIO₃), potassium niobate (KNbO₃), barium nitrate (Ba(NO₃)₂), solid-state raman shifters (KGd(WO₄)₂), potassium pentaborate, 3-methyl-4-nitropyridine-1 oxide, L-ariginine phosphate, and combinations thereof.

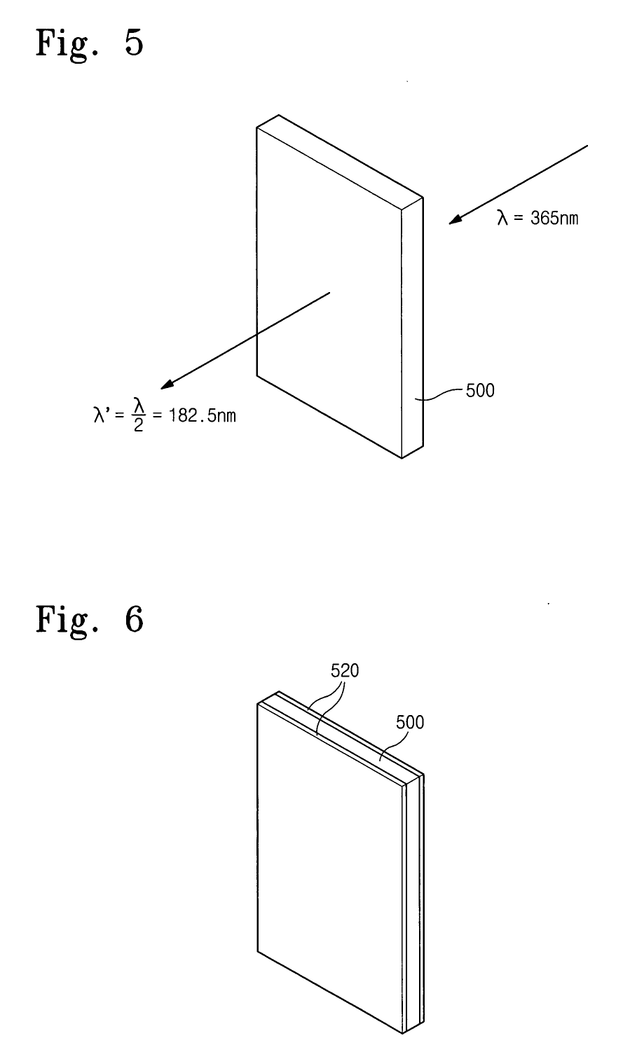

An anti-reflective coating film (ARC) (520 in FIG. 5) can be coated on a surface of the wavelength converter 500. The anti-reflective coating film (ARC) is made of one selected from the group consisting of zirconia (ZrO₂), magnesia (MgO), silica (SiO₂), titania (TiO₂), and combinations thereof.

FIG. 5 shows that a wavelength of i-line is reduced in half while passing the wavelength converter 500 made of a second harmonic generating material such as potassium titanyl phosphate (KTiOPO₄) or potassium dihydrogen phosphate (KH₂PO₄). For example, the wavelength of i-line (365 nm) is reduced in half (i.e., 182.5 nm) when passed through the wavelength converter 500.

As shown in FIG. 6, an anti-reflective coating film (ARC) 520 is coated on a surface of the wavelength converter 500 to prevent the converter 500 from an irregular reflection and to enhance transmissivity. A coating material is one selected from the group consisting of zirconia (ZrO₂), magnesia (MgO), silica (SiO₂), titania (TiO₂), and combinations thereof.

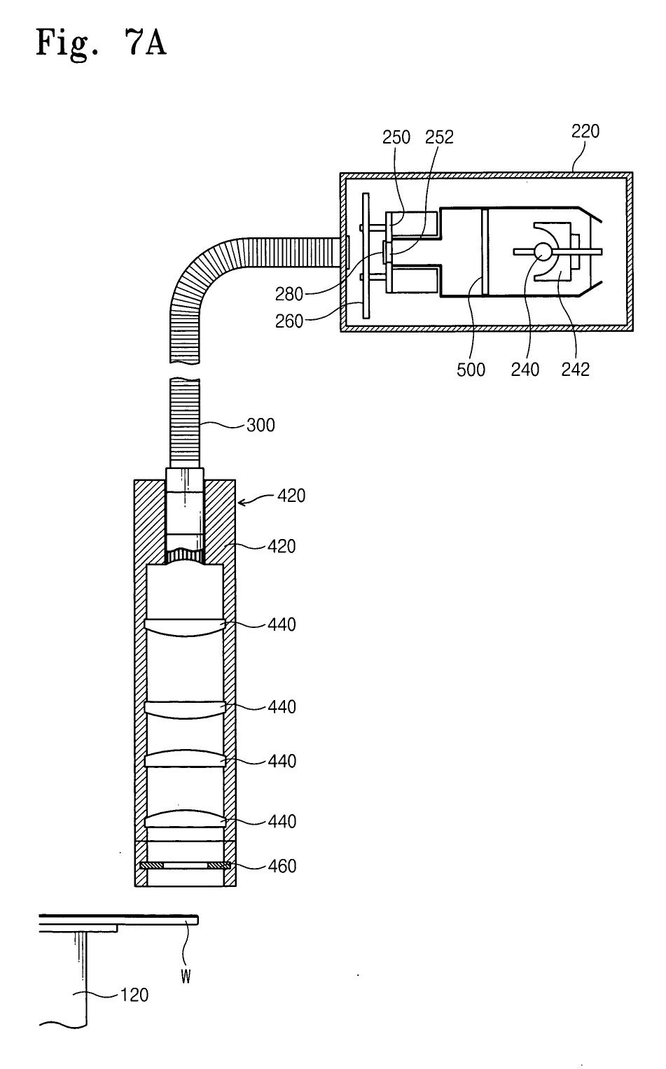

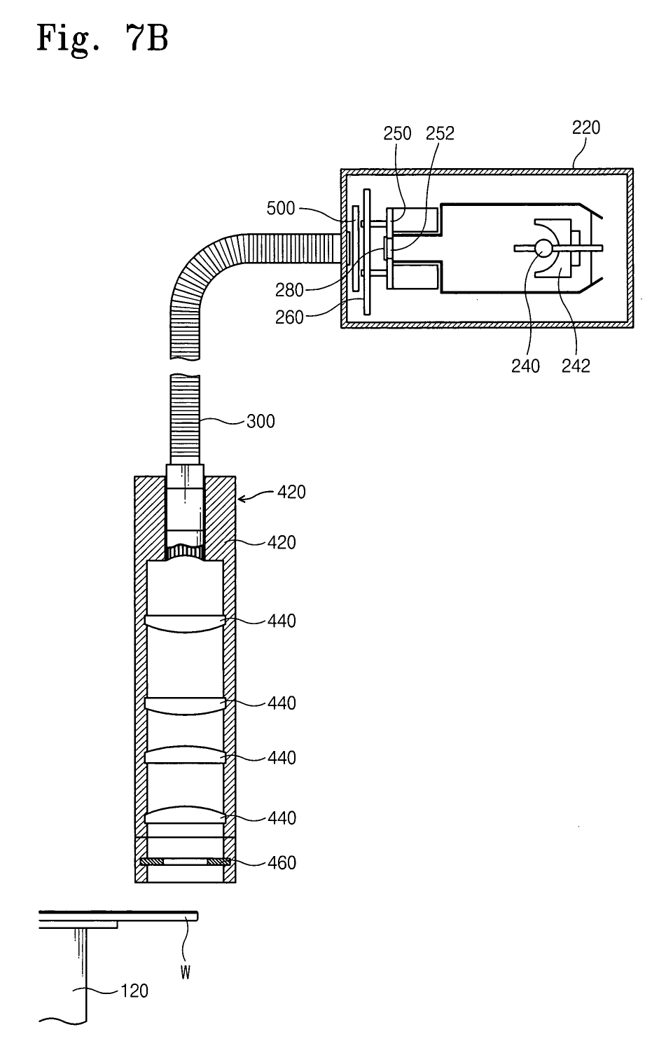

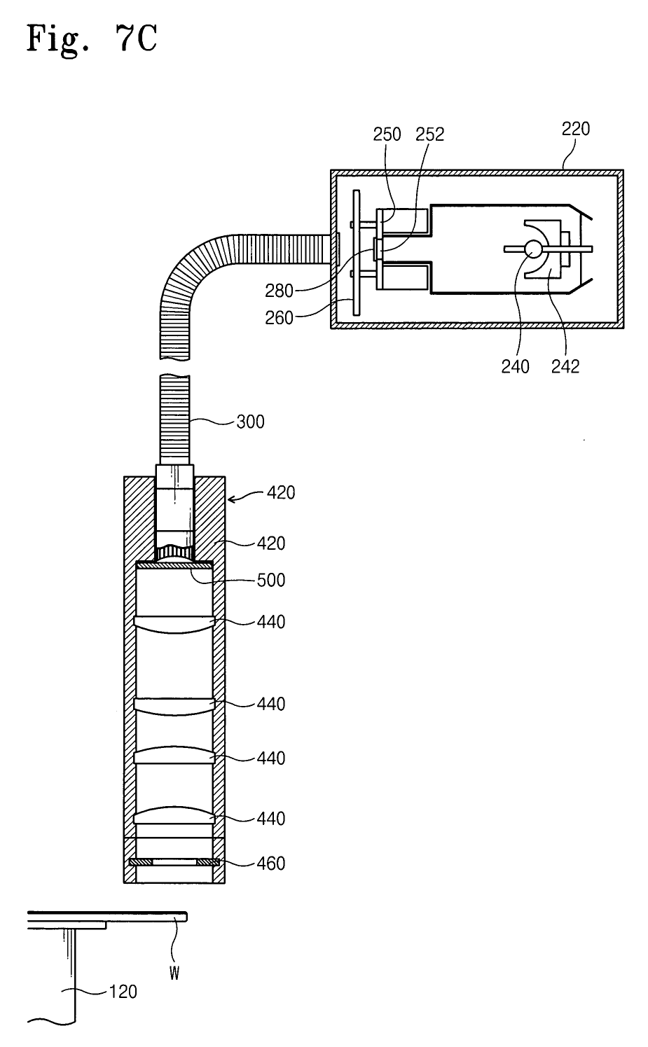

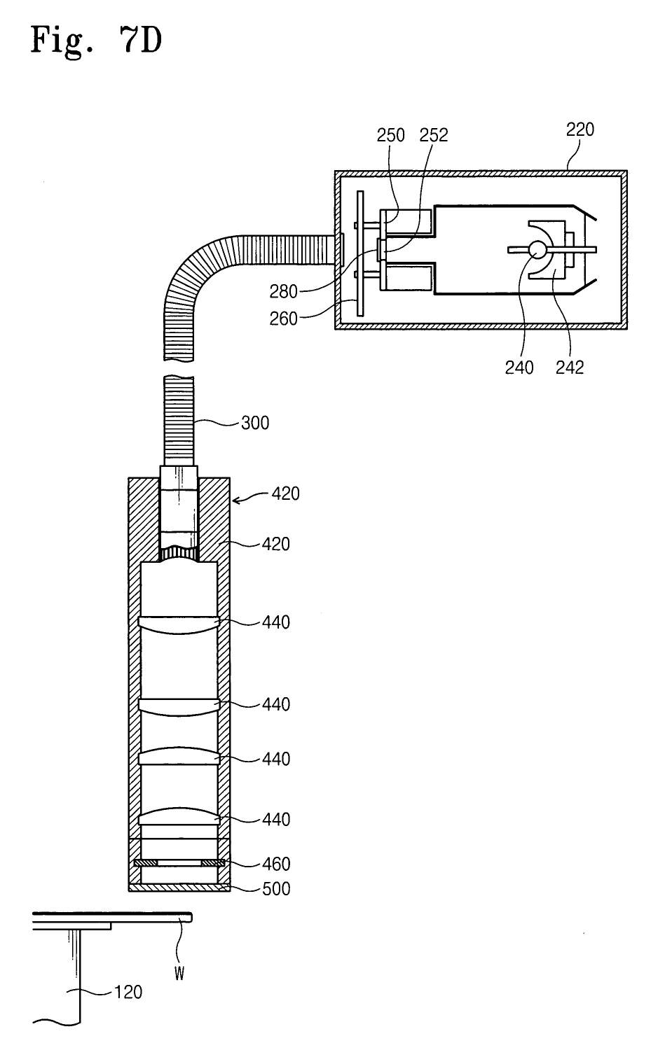

FIGS. 7A through 7D show different install positions of the wavelength converter 500. In preferred embodiments of the present invention, the wavelength converter 500 can be installed at any position between the lamp 240 and the wafer W. For example, the wavelength converter 500 can be installed in front of the light source 240, as shown in FIG. 7A.

The wavelength converter 500 can be installed between the optical fiber cord 300 and the filter 260, as shown in FIG. 7B. The wavelength converter 500 can be installed between the lens 440 and the optical fiber cord 300, as shown in FIG. 7C. The wavelength converter 500 may be installed at the end of the light-focusing device 400, as shown in FIG. 7D.

In general, light having a longer wavelength transmits easier in medium as compared to light having a shorter wavelength. Thus, positioning the wavelength converter 500 at the end of the light-focusing device 400 is preferred. To selectively use the wavelength converter 500, the wavelength converter 500 can be attached/-removed to/from the exposing device 20. The converter 500 converts a wavelength.

For example, the converter 500 reduces the wavelength to ½ or ⅓. Whether the wavelength is reduced to ½ or ⅓ is determined by types of a photoresist coated on the wafer W and types of a light source irradiating the wafer W. Light irradiating a wafer edge can be converted to have a wavelength fitted for resist coated on a wafer. Therefore, a lower-cost lamp such as a mercury arc lamp can be used to efficiently remove ArF resist at the wafer edge.

While the present invention has been described in detail with reference to the preferred embodiments, it is to be understood that the invention is not limited to the disclosed embodiments, but, on the contrary, is intended to cover various modifications and equivalent arrangements included within the spirit and scope of the appended claims.

What is claimed is:

1. A wafer edge exposing apparatus, comprising:
a light source device for generating source light;
an optical fiber cord for guiding the source light generated from the light source device into a light focusing device;
a lens positioned in the light focusing device to receive the source light from the optical fiber cord, the light focusing device to focus the source light to the edge of a wafer; and
a wavelength converter for converting a wavelength of the source light to a wavelength corresponding to the highest absorptivity of a photoacid generator of resist coated on the wafer.

2. The wafer edge exposing apparatus of claim 1, wherein the light source device includes a lamp, a parabolic or elliptical mirror, a plate, a shutter, and a filter.

3. The wafer edge exposing apparatus of claim 1, wherein the wavelength converter is made of an optically non-linear material.

4. The wafer edge exposing apparatus of claim 3, wherein the optically non-linear material is one selected from the group consisting of beta barium borate (β-BaB₂O₄), lithium triborate (LiB₃O₅), cesium lithium borate (CsLiB₆O₁₀), potassium titanyl phosphate (KTiOPO₄), potassium titanyl arsenate (KTiOAsO₄), potassium dihydrogen phosphate (KH₂PO₄), deuterated ammonium dihydrogen phosphate (KD₂PO₄), ammonium dihydrogen phosphate (NH₄H₂PO₄), deuterated ammonium dihydrogen phosphate (ND₄H₂PO₄), rubidium dihydrogen phosphate (RbH₂PO₄), cesium dihydrogen arsenate (CsH₂AsO₄), deuterated cesium dihydrogen arsenate (CsH₂AsO₄), lithium niobate (LiVbO₃), lithium tantelate (LiTaO₃), lithium iodata (LiIO₃), potassium niobate (KNbO₃), barium nitrate (Ba(NO₃)₂), solid-state raman shifters (KGd(W0₄)₂), potassium pentaborate, 3-methyl-4-nitropyridine-1 oxide, L-ariginine phosphate, and combinations thereof.

5. The wafer edge exposing apparatus of claim 1, wherein the resist is ArF resist.

6. The wafer edge exposing apparatus of claim 2, wherein the lamp is a mercury arc lamp.

7. The wafer edge exposing apparatus of claim 1, wherein the source light is i-line.

8. The wafer edge exposing apparatus of claim 1, wherein the source light is one of lights having a wavelength within the ultraviolet range.

9. The wafer edge exposing apparatus of claim 3, wherein the wavelength converter is made of either one of potassium titanyl phosphate (KTiOPO₄) and potassium dihydrogen phosphate (KH₂PO₄).

10. The wafer edge exposing apparatus of claim 2, wherein the wavelength converter is positioned in front of the lamp.

11. The wafer edge exposing apparatus of claim 2, wherein the wavelength converter is positioned between the optical fiber cord and the filter.

12. The wafer edge exposing apparatus of claim 1, wherein the wavelengths converter is positioned between the lens and the optical fiber cord.

13. The wafer edge exposing apparatus of claim 1, wherein the wavelength converter is installed at the end of the light-focusing device.

14. The wafer edge exposing apparatus of claim 1, wherein the wavelength converter is attachable/removable.

15. The wafer edge exposing apparatus of claim 1, wherein an anti-reflective coating film (ARC) is coated on surface of the wavelength converter.

16. The wafer edge exposing apparatus of claim 15, wherein the anti-reflective coating film (ARC) is made of one selected from the group consisting of zirconia (ZrO₂), magnesia (MgO), silica (SiO₂), titania (TiO₂), and combinations thereof.

17. A wafer edge exposing apparatus, comprising:
a light source device for generating a source light;
an optical fiber cord for guiding the source light;
a light focusing device for receiving the source light from the optical fiber cord and focusing the source light into a wafer; and
a wavelength converter for converting the wavelength of the source light to a wavelength corresponding to the highest absorptivity of a photoacid generator of resist coated on the wafer.

18. The wafer edge exposing apparatus of claim 17, wherein the wavelength converter is positioned in the light source device.

19. The wafer edge exposing apparatus of claim 18, wherein the wavelength converter is positioned in the light-focusing device.

20. The wafer edge exposing apparatus of claim 17, wherein the light source device includes a lamp, a parabolic or elliptical mirror, a plate, a shutter, and a filter.

21. The wafer edge exposing apparatus of claim 17, wherein the wavelength converter is made of an optically non-linear material.

22. The wafer edge exposing apparatus of claim 21, wherein the optically non-linear material is one selected from the group consisting of beta barium borate (β-BaB₂O₄), lithium triborate (LiB₃O₅), cesium lithium borate (CsLiB₆O₁₀), potassium titanyl phosphate (KTiOPO₄), potassium titanyl arsenate (KTiOAsO₄), potassium dihydrogen phosphate (KH₂PO₄), deuterated ammonium dihydrogen phosphate (KD₂PO₄), ammonium dihydrogen phosphate (NH₄H₂PO₄), deuterated ammonium dihydrogen phosphate (ND₄H₂PO₄), rubidium dihydrogen phosphate (RbH₂PO₄), cesium dihydrogen arsenate (CsH₂AsO₄), deuterated cesium dihydrogen arsenate (CsH₂AsO₄), lithium niobate (LiVbO₃), lithium tantelate (LiTaO₃), lithium iodata (LiIO₃), potassium niobate (KNbO₃), barium nitrate (Ba(NO₃)₂), solid-state raman shifters (KGd(WO₄)₂), potassium pentaborate, 3-methyl-4-nitropyridine-1 oxide, L-ariginine phosphate, and combinations thereof.

23. The wafer edge exposing apparatus of claim 17, wherein the resist coated on the wafer is ArF resist.

24. The wafer edge exposing apparatus of claim 20, wherein the lamp is a mercury arc lamp.

25. The wafer edge exposing apparatus of claim 17, wherein the source light is i-line.

26. The wafer edge exposing apparatus of claim 17, wherein the source light is one of lights having a wavelength within the ultraviolet range.

27. The wafer edge exposing apparatus of claim 17, wherein the wavelength converter is made of either one of potassium titanyl phosphate (KTiOPO₄) and potassium dihydrogen phosphate (KH₂PO₄).

28. The wafer edge exposing apparatus of claim 17, wherein the wavelength converter is attachable/removable.

29. The wafer edge exposing apparatus of claim 17, wherein an anti-reflective coating film (ARC) is coated on surface of the wavelength converter.

30. The wafer edge exposing apparatus of claim 29, wherein the anti-reflective coating film (ARC) is made of one selected from the group consisting of zirconia (ZrO₂), magnesia (MgO), silica (SiO₂), titania (TiO₂), and combinations thereof.
